(19) United States
(12) Patent Application Publication
(10) Pub. No.: US 2011/0054060 A1
(43) Pub. Date: Mar. 3, 2011

(54) NATURAL OIL BASED POLYOL BLENDS

(75) Inventors: Francois M. Casati, Pfaffikon (CH); Jean-Marie Sonney, Schindellegi (CH)

(73) Assignee: Dow Global Technologies Inc., Midland, MI (US)

(21) Appl. No.: 12/990,609

(22) PCT Filed: May 7, 2009
(86) PCT No.: PCT/US09/43141

§ 371 Date: Nov. 1, 2010

Related U.S. Application Data
(60) Provisional application No. 61/051,744, filed on May 9, 2008.

(51) Int. Cl. C08G 18/36; C09K 3/00

(52) U.S. Cl. 521/172; 252/182.24

(57) ABSTRACT

A natural oil based polyol blend is provided. The blend includes a first natural oil based polyol comprising is the reaction product of a first monomer and a first initiator, and where the first monomer is derived from at least one first fatty acid methyl ester. The blend also includes a second natural oil based polyol comprising the reaction product of a second monomer and a second initiator. The second monomer is derived from at least one second fatty acid methyl ester, and at least one of the second monomer and the second initiator is different from the first monomer and the first initiator, respectively. The natural oil based polyol blend may be reacted with an isocyanate to form a foam.

### CROSS-REFERENCE TO RELATED APPLICATIONS

This application claims benefit of U.S. Provisional Patent Application Ser. No. 61/051,744, filed May 9, 2008, entitled “NATURAL OIL BASED POLYOL BLENDS” which is herein incorporated by reference.

### BACKGROUND

1. Field of the Invention

Embodiments of the present invention generally relate to blends of polyols; more specifically, to blends of polyols based on renewable resources for use in polyurethane products.

2. Description of the Related Art

Polyether polyols based on the polymerization of alkylene oxides, polyester polyols, or combinations thereof, are together with isocyanates the major components of a polyurethane system. One class of polyols are conventional petroleum-based polyols, and another class are those polyols made from vegetable oils or other renewable feedstocks (so-called natural oil based polyols, or NOPB). Polyols based on renewable feedstocks may be sold and marketed as a component of polyol blends which often also may include conventional petroleum-based polyols as well as catalysts and other additives. These blends are then reacted with the isocyanates to form foams or other polyurethane products. However, using natural oil based polyols may in certain instances result in a reduced quality of the foam or foaming process. Therefore, there is a need for a method of producing polyurethane foams that result in an increased amount of renewable resources in the final polyurethane product while maintaining the foam's quality.

### SUMMARY

The embodiments of the present invention provide flexible polyurethane foams made by using natural oil-based polyols. In one embodiment, a natural oil based polyol blend is provided. The blend includes a first natural oil based polyol comprising the reaction product of a first monomer and a first initiator. The first monomer is derived from at least one first fatty acid methyl ester. The blend further includes a second natural oil based polyol comprising the reaction product of a second monomer and a second initiator. The second monomer is derived from at least one second fatty acid methyl ester, and at least one of the second monomer and the second initiator is different from the first monomer and the first initiator, respectively.

In another embodiment, a flexible polyurethane foam is provided. The foam includes a reaction product of an isocyanate and a natural oil based polyol blend. The natural oil based polyol blend includes a first natural oil based polyol comprising the reaction product of a first monomer and a first initiator, wherein the first monomer is derived from at least one first fatty acid methyl ester, and a second natural oil based polyol comprising the reaction product of a second monomer and a second initiator, wherein the second monomer is derived from at least one second fatty acid methyl ester, and at least one of the second monomer and the second initiator is different from the first monomer and the first initiator, respectively.

In another embodiment a method of producing a polyurethane foam is provided. The method includes reacting an isocyanate with a natural oil based polyol blend, wherein the natural oil based polyol blend compromises a first natural oil based polyol comprising the reaction product of a first monomer and a first initiator, wherein the first monomer is derived from at least one first fatty acid methyl ester, and a second natural oil based polyol comprising the reaction product of a second monomer and a second initiator, wherein the second monomer is derived from at least one second fatty acid methyl ester, and at least one of the second monomer and the second initiator is different from the first monomer and the first initiator, respectively.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

FIG. 1 is a flow diagram for a process for forming a natural oil based polyol, according to an embodiment of the invention.

FIG. 2 is a flow diagram for a process for forming a natural oil based polyol, according to another embodiment of the invention.

FIG. 3 is a flow diagram for a process for forming a natural oil based polyol, according to another embodiment of the invention.

FIG. 4 is a flow diagram for a process for forming a natural oil based polyols NOBP-1, NOBP-2, NOBP-3, and NOBP-4 according to an embodiment of the invention.

### DETAILED DESCRIPTION

Embodiments of the present invention provide for polyol blends which when processed into foams result in foams with high foam qualities at levels of renewable resources comparable to that of current available polyol blends.

Polyols are compounds that have at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates.

Natural oil based polyols (NOBP) are polyols based on or derived from renewable feedstock resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Examples of animal products include lard, beef tallow, fish oils and mixtures thereof. Additionally, oils obtained from organisms such as algae may also be used. A combination of vegetable, algae, and animal based oils/fats may also be used.

For use in the production of polyurethane foams, the natural material may be modified to give the material isocyanate reactive groups or to increase the number of isocyanate reactive groups on the material. Preferably such reactive groups are a hydroxyl group.

The modified natural oil derived polyols may be obtained by a multi-step process wherein the animal or vegetable oils/fats are subjected to transesterification and the constituent fatty acids recovered. This step is followed by hydroformylating carbon-carbon double bonds in the constituent fatty acids to form hydroxymethyl groups. Suitable hydroformylation methods are described in U.S. Pat. Nos. 4,731,486 and 4,633,021, for example, and in U.S. Patent Application No. 2006/0193802. The hydroxymethylated fatty acids are herein labeled “monomers” which form one of the building blocks for the natural oil based polyol. The monomers may be a single kind of hydroxymethylated fatty acid and/or hydroxymethylated fatty acid methyl ester, such as hydroxymethylated oleic acid or methylester thereof, hydroxymethylated linoleic acid or methylester thereof, hydroxymethylated linolenic acid or methylester thereof, α- and γ-linolenic acid or methyl ester thereof, myristoleic acid or methyl ester thereof, palmitoleic acid or methyl ester thereof, oleic acid or methyl ester thereof, vaccenic acid or methyl ester thereof, petroselinic acid or methyl ester thereof, gadoleic acid or methyl ester thereof, erucic acid or methyl ester thereof, nervonic acid or methyl ester thereof, stearidonic acid or methyl ester thereof, arachidonic acid or methyl ester thereof, timnodonic acid or methyl ester thereof, clupanodonic acid or methyl ester thereof, cervonic acid or methyl ester thereof, or hydroxymethylated ricinoleic acid or methylester thereof. In one embodiment, the monomer is hydroformulated methyloelate. Alternatively, the monomer may be the product of hydroformylating the mixture of fatty acids recovered from transesterifaction process of the animal or vegetable oils/fats. In one embodiment the monomer is hydroformulated soy bean fatty acids. In another embodiment the monomer is hydroformulated castor bean fatty acids. In another embodiment, the monomer may be a mixture of selected hydroxymethylated fatty acids or methylesters thereof.

A polyol is then formed by reacting the monomer with an appropriate initiator compound to form a polyester or polyether/polyester polyol. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil derived polyols may be any initiator used in the production of conventional petroleum-based polyols. Preferably the initiator is selected from the group consisting of neopentylglycol; 1,2-propylene glycol; trimethylolpropane; pentaerythritol; sorbitol; sucrose; glycerol; aminoalcohols such as ethanolamine, diethanolamine, and triethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. More preferably, the initiator is glycerol, trimethylopropane, pentaerythritol, sucrose, sorbitol, and/or mixture thereof.

In one embodiment, the initiators are alkoxlyated with ethylene oxide or a mixture of ethylene and at least one other alkylene oxide to give an alkoxylated initiator with a molecular weight between about 200 and about 6000, preferably between about 500 and about 5000. In one embodiment the initiator has a molecular weight of about 625, in another embodiment the molecular weight is about 550, and in yet another embodiment the initiator has a molecular weight of about 4600. In one embodiment, at least one initiator is a polyether initiator having an equivalent weight of at least about 480 or an average at least about 9.5 ether groups per active hydrogen group, such initiators are described in copending Patent Application No. PCT/US09/37751, filed on Mar. 20, 2009, entitled “Polyether Natural Oil Polyols and Polymers Thereof” the entire contents of which are incorporated herein by reference. In one embodiment, two initiators with two different molecular weights may be used. In one embodiment a first initiator may be the about 550 molecular weight initiator and the second initiator may be the about 625 molecular weight initiator.

Other initiators include other linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole.

The functionality of the resulting natural oil based polyols is above about 1.5 and generally not higher than about 6. In one embodiment, the functionality is below about 4. The hydroxyl number of the of the natural oil based polyols is below about 300 mg KOH/g, preferably between about 50 and about 300, more preferably between about 60 and about 200. In one embodiment, the hydroxyl number is below about 100.

The level of renewable feedstock in the natural oil based polyol can vary between about 10 and about 100%, usually between about 10 and about 90%.

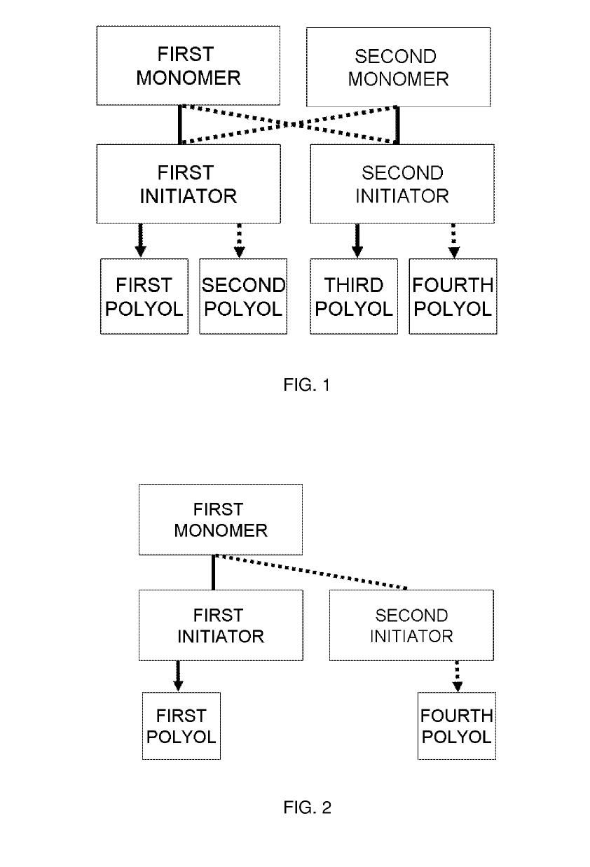

By combining the various possible monomers with the various possible initiators described above, a vast number of combinations are possible. FIGS. 1-3 are schematics showing four variations of natural oil based polyols obtainable by using two monomers and two initiators in preparing the natural oil based polyols. For the preparation of the natural oil based polyols the first monomer is combined either with the first initiator or the second initiator. Alternatively a fraction of the first monomer may be combined with the first initiator and a different fraction of the first monomer may be combined with the second initiator. Likewise, the second monomer is combined either with the first initiator or the second initiator. Alternatively a fraction of the second monomer may be combined with the first initiator and a different fraction of the second monomer may be combined with the second initiator. Additional monomers and/or initiators are possible resulting in even more combinations of natural oil based polyols. Two or more combinations of natural oil based polyols may be combined into a polyol blend in order to maximize the level of seed oil in the foam formulation, and/or to optimize foam processing and/or specific foam characteristics, such as open foams and increased resiliency (ball rebound).

In one embodiment of FIG. 1, the first monomer may be hydroformulated soy bean fatty acids and the second monomer may be hydroformulated methyloelate. The first initiator may be a 625 molecular weight poly(ethylene oxide)triol and the second initiator may be a 550 molecular weight poly(ethylene oxide/propylene oxide)triol. Alternatively, one initiator may be a 4600 molecular weight poly(ethylene oxide/propylene oxide)triol. The ratio of monomer to initiator may be at least about 3:1. In another embodiment the ratio is at least 4:1. In one embodiment the ratio is 4.1:1. In another embodiment the ratio is at least 5:1. In another embodiment the ratio is at least 6:1. In another embodiment the ratio is at least 7:1. In another embodiment the ratio is at least 8:1. In another embodiment the ratio is at least 9:1. In another embodiment the ratio is 9.9:1.

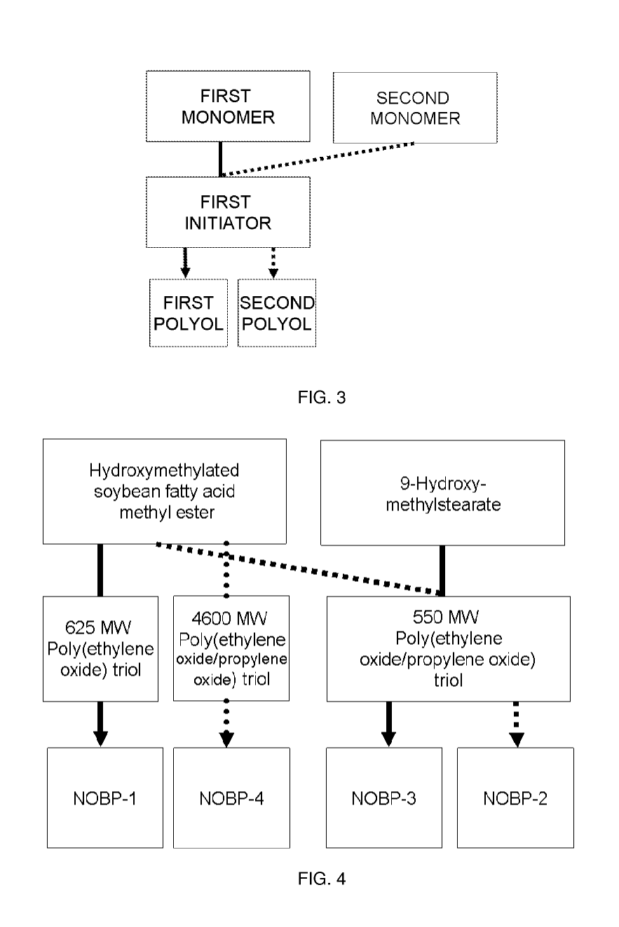

Alternatively, the combination of natural oil based polyols may result from a fraction of a first monomer being combined with the first initiator and a different fraction of the first monomer being combined with the second initiator (FIG. 2). Thus, two natural based polyols are obtained, both including the first polyol, but having different initiators. In FIG. 3, a first monomer and second monomer are both separately combined with a first initiator to obtain two natural oil based polyols, wherein both natural based oil polyols have the same initiator but different monomers. In the embodiments of FIGS. 1-3, any possible monomers described above may be either the first monomer or the second monomer and any possible initiator described above may be the first initiator or the second initiator.

FIG. 4 illustrates the components of the natural oil based polyols of the examples to follow (NOBP-1, NOBP-2, NOBP-3 and NOBP-4). The first monomer is hydroformulated soy bean fatty acids and the second monomer is hydroformulated methyloelate. The first initiator is 625 molecular weight poly(ethylene oxide)triol and the second initiator is a 550 molecular weight poly(ethylene oxide/propylene oxide)triol. There is also included a third initiator: a 4600 molecular weight poly(ethylene oxide/propylene oxide)triol.

In various embodiments of the invention, polyol blends used for preparing foams include at least two different combinations of natural oil based polyols as described above. The at least two different combinations of natural oil based polyols may constitute up to about 90 weight % of the polyol blend used. However, in a flexible foam, the natural oil based polyol may often constitute at least 5 weight %, at least 10 weight %, at least 25 weight %, at least 35 weight %, at least 40 weight %, at least 50 weight %, or at least 55 weight % of the total weight of the polyol blend. The natural oil based polyols may constitute 40% or more, 50 weight % or more, 60 weight % or more, 75 weight % or more, 85 weight % or more, 90 weight % or more, or 95 weight % or more of the total weight of the combined polyols. The viscosity measured at 25° C. of the natural oil derived polyols is generally less than about 6,000 mPa·s. Preferably, the viscosity is less than about 5,000 mPa·s. In embodiments of the invention, the ratio of at least two different combinations of natural oil based polyols may be between about 1:1 and about 5:1, preferably between about 1.5:1 and about 3:1. In another embodiment, the ratio is about 2:1. In another embodiment the ratio is about 3:2. In another embodiment, the ratio is about 5:3.

The polyol blend may optionally include another kind of polyol, which includes at least one conventional petroleum-based polyol. The at least one conventional petroleum-based polyol includes materials having at least one group containing an active hydrogen atom capable of undergoing reaction with an isocyanate, and not having parts of the material derived from a vegetable or animal oil. Suitable conventional petroleum-based polyols are well known in the art and include those described herein and any other commercially available polyol. Mixtures of one or more polyols and/or one or more polymer polyols may also be used to produce polyurethane products according to embodiments of the present invention.

Representative polyols include polyether polyols, polyester polyols, polyhydroxy-terminated acetal resins, hydroxyl-terminated amines and polyamines. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound. The initiators suitable for the natural oil based polyols may also be suitable for the at least one conventional petroleum-based polyol.

The at least one conventional petroleum-based polyol may for example be poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide. For slabstock foam applications, such polyethers preferably contain 2-5, especially 2-4, and preferably from 2-3, mainly secondary hydroxyl groups per molecule and have an equivalent weight per hydroxyl group of from about 400 to about 3000, especially from about 800 to about 1750. For high resiliency slabstock and molded foam applications, such polyethers preferably contain 2-6, especially 2-4, mainly primary hydroxyl groups per molecule and have an equivalent weight per hydroxyl group of from about 1000 to about 3000, especially from about 1200 to about 2000. When blends of polyols are used, the nominal average functionality (number of hydroxyl groups per molecule) will be preferably in the ranges specified above. For viscoelastic foams shorter chain polyols with hydroxyl numbers above 150 are also used. For the production of semi-rigid foams, it is preferred to use a trifunctional polyol with a hydroxyl number of 30 to 80.

The polyether polyols may contain low terminal unsaturation (for example, less that 0.02 meq/g or less than 0.01 meq/g), such as those made using so-called double metal cyanide (DMC) catalysts. Polyester polyols typically contain about 2 hydroxyl groups per molecule and have an equivalent weight per hydroxyl group of about 400-1500.

The conventional petroleum-based polyols may be a polymer polyol. In a polymer polyol, polymer particles are dispersed in the conventional petroleum-based polyol. Such particles are widely known in the art an include styrene-acrylonitrile (SAN), acrylonitrile (ACN), polystyrene (PS), methacrylonitrile (MAN), or methyl methacrylate (MMA) particles. In one embodiment the polymer particles are SAN particles.

The conventional petroleum-based polyols may constitute up to about 10 weight %, 20 weight %, 30 weight %, 40 weight %, 50 weight %, or 60 weight % of polyol formulation. The conventional petroleum-based polyols may constitute at least about 1 weight %, 5 weight %, 10 weight %, 20 weight %, 30 weight %, or 50 weight % of polyol formulation.

In addition to the above described polyols, the polyol blend may also include other ingredients such as catalysts, silicone surfactants, preservatives, and antioxidants,

The polyol blend may be used in the production of polyurethane products, such as polyurethane foams, elastomers, microcellular foams, adhesives, coatings, etc. For example, the polyol blend may be used in a formulation for the production of flexible polyurethane foam. For the production of a polyurethane foam the polyol blend may be combined with additional ingredients such as catalysts, crosslinkers, emulsifiers, silicone surfactants, preservatives, flame retardants, colorants, antioxidants, reinforcing agents, fillers, including recycled polyurethane foam in form of powder.

Any suitable urethane catalyst may be used, including tertiary amine compounds, amines with isocyanate reactive groups and organometallic compounds. Exemplary tertiary amine compounds include triethylenediamine, N-methylmorpholine, N,N-dimethylcyclohexylamine, pentamethyldiethylenetriamine, tetramethyl-ethylenediamine, bis(dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino- propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate. A catalyst for the trimerization of isocyanates, resulting in a isocyanurate, such as an alkali metal alkoxide may also optionally be employed herein. The amount of amine catalysts can vary from 0 to about 5 percent in the formulation or organometallic catalysts from about 0.001 to about 1 percent in the formulation can be used.

One or more crosslinkers may be provided, in addition to the polyols described above. This is particularly the case when making high resilience slabstock or molded foam. If used, suitable amounts of crosslinkers are from about 0.1 to about 1 part by weight, especially from about 0.25 to about 0.5 part by weight, per 100 parts by weight of polyols.

The crosslinkers may have three or more isocyanate-reactive groups per molecule and an equivalent weight per isocyanate-reactive group of less than 400. The crosslinkers preferably may include from 3-8, especially from 3-4 hydroxyl, primary amine or secondary amine groups per molecule and have an equivalent weight of from 30 to about 200, especially from 50-125. Examples of suitable crosslinkers include diethanol amine, monoethanol amine, triethanol amine, mono- di- or tri(isopropanol) amine, glycerine, trimethylol propane, pentaerythritol, and sorbitol.

It is also possible to use one or more chain extenders in the foam formulation. The chain extender may have two isocyanate-reactive groups per molecule and an equivalent weight per isocyanate-reactive group of less than 400, especially from 31-125. The isocyanate reactive groups are preferably hydroxyl, primary aliphatic or aromatic amine or secondary aliphatic or aromatic amine groups. Representative chain extenders include amines ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene. If used, chain extenders are typically present in an amount from about 1 to about 50, especially about 3 to about 25 parts by weight per 100 parts by weight high equivalent weight polyol.

A polyether polyol may also be included in the formulation, i.e, as part of the at least one conventional petroleum-based polyol, to promote the formation of an open-celled or softened polyurethane foam. Such cell openers generally have a functionality of 2 to 12, preferably 3 to 8, and a molecular weight of at least 5,000 up to about 100,000. Such polyether polyols contains at least 50 weight percent oxyethylene units, and sufficient oxypropylene units to render it compatible with the components. The cell openers, when used, are generally present in an amount from 0.2 to 5, preferably from 0.2 to 3 parts by weight of the total polyol. Examples of commercially available cell openers are VORANOL Polyol CP 1421 and VORANOL Polyol 4053; VORANOL is a trademark of The Dow Chemical Company.

The formulations may then be reacted with, at least one isocyanate to form a flexible polyurethane foam. Isocyanates which may be used in the present invention include aliphatic, cycloaliphatic, arylaliphatic and aromatic isocyanates.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, 1,3-bis(isocyanatomethyl)cyclohexane, 1,4-bis(isocyanatomethyl)cyclohexane, saturated analogues of the above mentioned aromatic isocyanates, and mixtures thereof.

The at least one isocyanate is added to the blend for an isocyanate index of between about 30 and about 150, preferably between about 50 and about 120, more preferably between about 60 and about 110. The isocyanate index is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

For the production of flexible foams, the polyisocyanates may often be the toluene-2,4- and 2,6-diisocyanates or MDI or combinations of TDI/MDI or prepolymers made therefrom.

Isocyanate tipped prepolymer may also be used in the polyurethane formulation. Such prepolymers are obtained by the reaction of an excess of polyol. The polyol may be the conventional petroleum-based polyol, the natural oil derived polyol, the amine initiated polyol, and/or a combination of the polyols.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

In general, the polyurethane foam is prepared by mixing the polyisocyanate of and polyol composition in the presence of the blowing agent, catalyst(s) and other optional ingredients as desired under conditions such that the polyisocyanate and polyol composition react to form a polyurethane and/or polyurea polymer while the blowing agent generates a gas that expands the reacting mixture. The foam may be formed by the so-called prepolymer method, in which a stoichiometric excess of the polyisocyanate is first reacted with the high equivalent weight polyol(s) to form a prepolymer, which is in a second step reacted with a chain extender and/or water to form the desired foam. Frothing methods are also suitable. So-called one-shot methods may be preferred. In such one-shot methods, the polyisocyanate and all polyisocyanate-reactive are simultaneously brought together and caused to react. Three widely used one-shot methods which are suitable for use in this invention include slabstock foam processes, high resiliency slabstock foam processes, and molded foam methods.

Slabstock foam is conveniently prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are typically from about from about 10 kg/m³ to 80 kg/m³, especially from about 15 kg/m³ to 60 kg/m³, preferably from about 17 kg/m³ to 50 kg/m³ in density.

A preferred slabstock foam formulation contains from about 3 to about 6, preferably about 4 to about 5 parts by weight water are used per 100 parts by weight high equivalent weight polyol at atmospheric pressure. At reduced pressure these levels are reduced.

High resilience slabstock (HR slabstock) foam is made in methods similar to those used to make conventional slabstock foam but using higher equivalent weight polyols. HR slabstock foams are characterized in exhibiting a Ball rebound score of 45% or higher, per ASTM 3574.03. Water levels tend to be from about 2 to about 6, especially from about 3 to about 5 parts per 100 parts (high equivalent) by weight of polyols.

Molded foam can be made according to the invention by transferring the reactants (polyol composition including copolyester, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, can be used. Cold-molding processes are preferred to produce high resilience molded foam. Densities for molded foams generally range from 30 to 50 kg/m³.

By including at least two different combinations of natural oil based polyols made through the same process, although with different monomers and/or different initiators, the foaming process is maintained at quality levels which may be difficult to obtain when using a polyol blend having a similar level of renewable content, but with only one kind of natural oil based polyol. Furthermore, the resulting foams have more open properties and higher resiliency values.

For example, the polyol blends (mixture natural oil based polyols and conventional petroleum-based polyols) used to produce flexible foam may have a a renewable content of at least 26%. In one embodiment the renewable content is at least 27%. In another embodiment the renewable content is at least 28%. In another embodiment the renewable content is at least 29%. In another embodiment the renewable content is at least 30%. In another embodiment the renewable content is at least 31%. In another embodiment the renewable content is at least 32%. The resulting flexible foam may a resilience of at least 42%. In one embodiment the resilience the resilience is at least 43%. In another embodiment the resilience the resilience is at least 44%. In another embodiment the resilience the resilience is at least 45%. In another embodiment the resilience the resilience is at least 46%. In another embodiment the resilience the resilience is at least 47%. In another embodiment the resilience the resilience is at least 48%. By combing at least two combinations of natural oil polyols it may be possible to obtain flexible foams having higher resilience values than may be obtained, at similar renewable contents levels, when using a single combination of natural oil polyol in the polyol foaming blends.

### EXAMPLES

The following examples are provided to illustrate the embodiments of the invention, but are not intended to limit the scope thereof. All parts and percentages are by weight unless otherwise indicated.

The following materials were used:
Diethanolamine: Available from the Sigma-Aldrich Co.
DABCO 33LV: A 33% solution of triethylenediamine in propylene glycol available from Air Products & Chemicals Inc.
NIAX A-1: A tertiary amine catalyst available from Momentive Performance Materials.
NIAX A-300: A tertiary amine catalyst available from Momentive Performance Materials.
TEGOSTAB B 8715LF: A silicone-based surfactant available from Degussa-Goldschmidt Corporation.
SPECFLEX* NC 632: A 1,700 equivalent weight polyoxypropylene polyoxyethylene polyol initiated with a blend of glycerol and sorbitol. Available from The Dow Chemical Company.
SPECFLEX* NC 700: A grafted polyether polyol containing 40% copolymerized styrene and acrylonitrile (SAN). Available from The Dow Chemical Company.
SPECFLEX* NE 134: An MDI based prepolymer having a free NCO content of about 29.5%. Available from The Dow Chemical Company.
SPECFLEX* TM 20: A 80% Voranate T-80 (80% 2,4-toluene diisocyanate and 20% 2,6-toluene diisocyanate by weight) and 20% Voranate M-229 (a polymeric MDI) by weight blend available from The Dow Chemical Company
VORANOL* CP 6001: A 2000 equivalent weight propoxylated triol capped with 15% Ethylene oxide. Available from The Dow Chemical Company.
VORANOL* CP 1421: A 1700 equivalent weight random copolymer of 25 percent propylene oxide and 75 percent ethylene oxide. Available from The Dow Chemical Company.
NOBP-1: A soybean oil based polyol prepared according to example NOPO-1 of copending U.S. Provisional Patent Application No. 60/930,332, filed on May 15, 2007, entitled “High resilience foams,” the entire contents of which are incorporated herein by reference. The monomers are hydroxymethylated soybean fatty acid methyl esters and the initiator is a 625 molecular weight poly(ethylene oxide) triol used at a molar ratio of monomer to initiator of 4.1:1. NOBP-1 has a hydroxyl number of 89.
NOBP-2: A soybean oil based polyol prepared in a similar manner as NOPB-1, but with the initiator being a 550 molecular weight poly(ethylene oxide/propylene oxide) triol made by reacting 27 moles of ethylene oxide onto a glycerol initiated triol containing 8 moles of propylene oxide. The molar ratio of monomer to initiator is 9.9:1. NOBP-2 has a hydroxyl number of 37.
NOBP-3: A soybean oil based polyol prepared in a similar manner as NOPB-2, but the monomer is 9(10)-hydroxymethylstearate (prepared by hydroformylating and reducing methyl oleate). The molar ratio of monomer to initiator is 9.9:1. NOBP-3 has a hydroxyl number of 34.
NOBP-4: A soybean oil based polyol prepared according to Example 6 of copending Patent Application No. PCT/US09/37751, filed on Mar. 20, 2009, entitled “Polyether Natural Oil Polyols and Polymers Thereof” the entire contents of which are incorporated herein by reference. The monomers are hydroxymethylated soybean fatty acid methyl esters and the initiator is a 4600 molecular weight poly(ethylene oxide/propylene oxide) triol. The molar ratio of monomer to initiator is 4.55:1. NOBP-4 has a hydroxyl number of 29.
   *SPECFLEX and VORANOL are trademarks of The Dow Chemical Company

### Examples 1-6 and Comparative Examples 1 and 2

Foams (examples E1-E6 and comparative examples C1 and C2) are made by preblending the components of Table 1, except for the isocyanate, all conditioned at 25° C. The isocyanate, SPECFLEX* NE 134, is separately conditioned at 25° C. Foam is produced by hand mixing at 2,000 RPM for 5 seconds before reactants are poured into a 300×300×10 mm aluminium mold, heated at 60° C., equipped with vent-holes. The mold release agent is Kluber 41-2038, available from Chem-Trend. Demolding time is 4 minutes.

Core density is measured according to ASTM D3574-95 after removal of any skin that forms on the surface of a molded or free rise foam pad.

50% CFD is a measure of the compression deflection of a flexible material (for instance, foam) measured as the force in kPa required to compress a 5 cm thick sample no smaller than 100 cm square, to 50 percent deflection after 4 precycles. The CFD is measured according to the procedures of DIN 53577

Air flow is the volume of air which passes through a 1.0 inch (2.54 cm) thick 2 inch×2 inch (5.08 cm) square section of foam at 125 Pa (0.018 psi) of pressure. Units are expressed in cubic decimeters per second and converted to standard cubic feet per minute. A representative commercial unit for measuring air flow is manufactured by TexTest AG of Zurich, Switzerland and identified as TexTest Fx3300. This measurement follows ASTM D 3574 Test G.

Resilience refers to the quality of a foam perceived as springiness. It is measured according to the procedures of ASTM D3574 Test H. This ball rebound test measures the height a dropped steel ball of known weight rebounds from the surface of the foam when dropped under specified conditions and expresses the result as a percentage of the original drop height. As measured according to the ASTM test, an HR foam exhibits a resiliency of at least about 40 percent, more preferably at least about 42 percent, most preferably at least about 48 percent and advantageously up to about 50 percent.

75% CS is the dry compression set test measured at the 75 percent compressive deformation level and parallel to the rise direction in the foam. This test is used herein to correlate in-service loss of cushion thickness and changes in foam thickness. The compression set is determined according to the procedures of ASTM D 3574-95, Test I. and is measured as percentage of original thickness of the sample. Similarly, “50% CS” refers to the same measurement (compression set), but this time measured at 50 percent compressive deformation level of the sample, parallel to the rise direction in the foam.

50% HACS is the humid aged compression set test measured at the 50 percent of compressive deformation and parallel to the rise direction in the foam. This test is used herein to correlate in-service loss and changes in foam thickness. The 50 percent compression set is determined according to the procedures of DIN 53578 and is measured as percentage of original thickness of the sample.

TABLE 1

| | C1 | C2 | E1 | E2 | E3 | E4 | E5 | E6 |
|---|---|---|---|---|---|---|---|---|
| VORANOL* CP 6001 | 50 | 60 | 50 | 50 | 60 | 60 | | |
| VORANOL* CP 1421 | 2.0 | 2.0 | 2.0 | 2.0 | 2.0 | 2.0 | | |
| SPECFLEX* NC 632 | | | | | | | | 20 |
| SPECFLEX* NC 700 | | | | | | | 10 | 10 |
| NOBP-1 | 50 | 40 | 20 | 20 | 20 | 20 | 30 | 20 |
| NOBP-2 | | | 30 | | 20 | | | |
| NOBP-3 | | | | 30 | | 20 | | |
| NOBP-4 | | | | | | | 60 | 50 |
| Water | 4.0 | 4.0 | 4.0 | 4.0 | 4.0 | 4.0 | 3.5 | 3.5 |
| DEOA | 0.5 | 0.5 | 0.5 | 0.5 | 0.5 | 0.5 | 0.7 | 0.7 |
| Niax A-1 | 0.05 | 0.05 | 0.05 | 0.05 | 0.05 | 0.05 | 0.05 | 0.05 |
| Dabco 33 LV | 0.40 | 0.40 | 0.40 | 0.40 | 0.40 | 0.40 | 0.3 | 0.3 |
| Tegostab B8715LF | 1.5 | 1.5 | 1.5 | 1.5 | 1.5 | 1.5 | 0.5 | 0.5 |
| SPECFLEX* NE 134 index | 85 | 85 | 85 | 85 | 85 | 85 | | |
| SPECFLEX* TM 20 index | | | | | | | 95 | 95 |
| % renewable in polyol blend | 34.3 | 27.5 | 31.6 | 32.3 | 26.3 | 26.3 | 24.5 | 18.1 |
| Observation at demold | foam tight | Foam tight | foam open | foam open | foam open | foam open | Foam open | foam open |
| Core density (kg/m³) | 40.5 | 41.3 | 42.7 | 40.7 | 40.6 | 41.3 | 37.9 | 37.6 |
| 50% CFD (KPa) | 4.9 | 4.9 | 3.9 | 4.1 | 4.4 | 4.4 | 4.0 | 4.0 |
| Airflow (cfm) | 2.5 | 2.8 | 2.8 | 2.8 | 3.0 | 2.9 | 3.6 | 3.8 |
| Resilience (%) | 36 | 42 | 42 | 44 | 46 | 48 | 41 | 47 |
| 75% CS (% CD) | 16.4 | 11.7 | 13.9 | 10.2 | 11.0 | 8.8 | 12.7 | 10.6 |
| 50% HACS (%) | 23.3 | 19.1 | 16.2 | 14.1 | 11.9 | 12.7 | Not Measured | Not Measured |

By substituting part of NOBP-1 with either NOBP-2 or NOBP-3, NOBP-4 foam processing is improved as shown by more open foam pads after the foam is removed from the mold. Additionally, overall foam properties are improved, especially foam resiliency (ball rebound) and the dry and humid aged compression sets. Therefore, by using a combination of these NOPBs it is possible to obtain foams with high foam qualities at levels of renewable resources similar to that of the comparison examples without jeopardizing foam processing (foam tightening).

While the foregoing is directed to embodiments of the present invention, other and further embodiments of the invention may be devised without departing from the basic scope thereof, and the scope thereof is determined by the claims that follow.

1. A natural oil based polyol blend, comprising:
a first natural oil based polyol comprising the reaction product of a first monomer and a first initiator, wherein the first monomer is derived from at least one first fatty acid methyl ester; and
a second natural oil based polyol comprising the reaction product of a second monomer and a second initiator, wherein the second monomer is derived from at least one second fatty acid methyl ester, and at least one of the second monomer and the second initiator is different from the first monomer and the first initiator, respectively.

2. A flexible polyurethane foam, comprising:
a reaction product of
an isocyanate and
a natural oil based polyol blend, comprising:
a first natural oil based polyol comprising the reaction product of a first monomer and a first initiator, wherein the first monomer is derived from at least one first fatty acid methyl ester, and
a second natural oil based polyol comprising the reaction product of a second monomer and a second initiator, wherein the second monomer is derived from at least one second fatty acid methyl ester, and at least one of the second monomer and the second initiator is different from the first monomer and the first initiator, respectively.

3. The natural oil based polyol blend of claim 1, wherein the first monomer and the second monomer comprises hydroformulated fatty acid methyl esters.

4. The natural oil based polyol blend claim 1, wherein the first monomer and the second monomer are different monomers.

5. The natural oil based polyol blend claim 1, wherein at least one of the first monomer and second monomer is hydroxymethylated soybean fatty acid methyl esters.

6. The natural oil based polyol blend claim 1, wherein at least one of the first monomer and second monomer is 9(10)-hydroxymethylstearate.

7. The natural oil based polyol blend claim 1, wherein at least one of the first monomer and second monomer is hydroxymethylated castor bean fatty acid methyl esters.

8. The natural oil based polyol blend claim 1, wherein at least one of the first initiator and second initiator is a 625 molecular weight poly(ethylene oxide) triol.

9. The natural oil based polyol blend claim 1, wherein at least one of the first initiator and second initiator is a 550 molecular weight poly(ethylene oxide/propylene oxide) triol.

10. The natural oil based polyol blend claim 1, wherein at least one of the first initiator and second initiator is a 4600 molecular weight poly(ethylene oxide/propylene oxide) triol.

11. The natural oil based polyol blend claim 1, wherein at least one of the first natural oil based polyol and the second natural oil based polyol has a monomer to initiator ratio of at least about 4:1.

12. The natural oil based polyol blend claim 11, wherein the ratio is at least about 9:1.

13. The flexible polyurethane foam of claim 2, wherein the natural oil based polyol blend further comprises at least one conventional petroleum-based polyol and has a renewable content of at least 26%, and the flexible polyurethane foam has a resilience of at least 42%.

14. The flexible polyurethane foam of claim 13, wherein the resilience is at least 46%.

15. The flexible polyurethane foam of claim 13, wherein the renewable content is at least 31%.

16. A method of producing a polyurethane foam, comprising:
reacting an isocyanate with the natural oil based polyol blend of claim 1.

17. The polyurethane foam of claim 2, wherein the first monomer and the second monomer comprises hydroformulated fatty acid methyl esters.

18. The flexible polyurethane foam of any one of claim 2, wherein the first monomer and the second monomer are different monomers.

19. The flexible polyurethane foam of any one of claim 2, wherein at least one of the first monomer and second monomer is hydroxymethylated soybean fatty acid methyl esters.

20. The flexible polyurethane foam of any one of claim 2, wherein at least one of the first monomer and second monomer is 9(10)-hydroxymethylstearate.
